(19) United States
(12) Patent Application Publication
(10) Pub. No.: US 2011/0153511 A1
(43) Pub. Date: Jun. 23, 2011

(54) DEVICE, METHOD FOR MANAGING DISTRIBUTED SERVICE LEVEL AGREEMENT QUALITY INFORMATION AND MANAGEMENT SYSTEM OF SERVICE LEVEL AGREEMENT

(75) Inventors: Mi Kyong Han, Daejeon (KR); Byung Yun Lee, Daejeon (KR); Byung Sun Lee, Daejeon (KR)

(73) Assignee: ELECTRONICS AND TELECOMMUNICATIONS RESEARCH INSTITUTE, Daejeon (KR)

(21) Appl. No.: 12/971,214

(22) Filed: Dec. 17, 2010

(30) Foreign Application Priority Data
Dec. 18, 2009 (KR) 10-2009-0127086

(51) Int. Cl. G06Q 10/00

(52) U.S. Cl. 705/317

(57) ABSTRACT

A device for discretely managing quality of an SLA according to the present invention is an SLA quality information management device for managing quality of service level agreement, including: a data management unit that shares SLA quality information generated by each of a provisioning management device, a fault management device, and a network quality management device with the provisioning management device, the fault management device, and the network quality management device and stores it; a statistic processing unit that generates SLA quality statistical information based on the SLA quality information; and a compensation processing unit that processes compensation for violation of the SLA quality based on the SLA quality statistical information.

### CROSS-REFERENCE TO RELATED APPLICATION

This application claims priority to and the benefit of Korean Patent Application No. 10-2009-0127086 filed in the Korean Intellectual Property Office on Dec. 18, 2009, the entire contents of which are incorporated herein by reference.

### BACKGROUND OF THE INVENTION

(a) Field of the Invention

The present invention relates to a device and method for managing distributed service level agreement quality information and a management system of a service level agreement.

(b) Description of the Related Art

A service level agreement (SLA) is an agreement that provides a service corresponding to a previously defined level from a service provider to a service subscriber by an agreement between them. Generally, a SLA management system is designed in a form that collects quality information from systems for managing provisioning, faults, and network quality, respectively, configures information necessary for the service level agreement, and monitors these.

The known system for a SLA management system interacts with convergence systems, such as a provisioning management system, a fault manangement system, a network quality management system, etc. to collect acceptance information or processed information, thereby configuring information necessary for managing quality of a service level agreement. Therefore, during the collection of the information from the convergence systems, it is difficult to collect the information in real time due to the problem that the collection function or the network and the information is likely to be lost. In addition, while the SLA management system analyzes and grasps the functions of the convergence system and reflects them to match the functions of the SLA management system, it is difficult to reflect the business logic change or the addition and deletion of the functions of the convergence system.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to improve reliability of data by minimizing an error of information for managing quality and by securing real time in managing quality of a service level agreement. In addition, the present invention has been made in an effort to provide a system for discretely managing quality of a service level agreement that is capable of efficiently performing a system operation by actively reflecting a change in functions, etc. of an convergence system into a system for managing a quality of service level agreement.

An exemplary embodiment of the present invention provides a device for discretely managing quality of an SLA that is an SLA quality information management device managing quality of a service level agreement (SLA), the SLA quality information management device including: a data management unit that shares SLA quality information generated by each of the provisioning management device, fault management device, and network quality management device with the provisioning management device, the fault management device, and the network quality management device and stores it; a statistical processing unit that generates SLA quality statistical information based on the SLA quality information; and a compensation processing unit that processes compensation for violation of the SLA quality based on the SLA quality statistical information.

The data management unit may further receive and store subscriber information from the provisioning management device.

Another exemplary embodiment of the present invention provides a method for discretely managing quality of an SLA that is an SLA quality managing method by a provisioning management device, the SLA quality managing method including: determining whether provisioning information is provisioning subscription information or provisioning completion information by receiving the provisioning information; when the provisioning information is the provisioning subscription information, performing monitoring information generation for monitoring the SLA quality and provisioning subscription management; and when the provisioning information is the provisioning completion information, determining whether it violates the SLA quality and building the SLA quality information.

The performing the provisioning subscription management may include: confirming whether a subscriber is an object of the SLA management; generating SLA quality monitoring information for the subscriber; when there is the possibility of the SLA provisioning quality violation, issuing an alarm of the SLA provisioning quality violation to an operation manager; and storing SLA provisioning quality monitoring history information.

The SLA quality managing method may further include, after the building the SLA quality information: confirming the violation or non-violation of the SLA quality using the built SLA quality information; if it is determined that it violates the SLA quality, transmitting SLA quality violation information to a device for discretely managing quality of an SLA that performs a compensation process; and transmitting the SLA quality history information to the device for discretely managing quality of the SLA.

The SLA quality managing method may further include transmitting the information on the subscriber to the device for discretely managing quality of an SLA.

Still another exemplary embodiment of the present invention provides an SLA quality managing method by a fault management device, the SLA quality managing method including: determining whether fault information is fault acceptance information or fault recovered information by receiving fault information; when the fault information is the fault acceptance information, generating SLA quality monitoring information and performing fault processing; and when the fault information is the fault recovered information, determining SLA quality violation and building SLA quality information.

The performing the fault processing may include: confirming whether a subscriber is an object of the SLA management; generating SLA quality monitoring information for the subscriber; when there is a possibility of the SLA provisioning quality violation, issuing an alarm of the SLA provisioning quality violation to an operation manager; and storing SLA provisioning quality monitoring history information.

The SLA quality managing method may further include: after the building the SLA quality information, confirming the violation or non-violation of the SLA quality using the built SLA quality information; if it is determined that it violates the SLA quality, transmitting SLA quality violation information to a device for discretely managing quality of an SLA that performs a compensation process; and transmitting the SLA quality history information to the device for discretely managing quality of the SLA.

The SLA quality managing method may further include confirming the subscriber followed by performing the fault processing.

Another exemplary embodiment of the present invention provides a method for discretely managing quality of an SLA that is an SLA quality managing method by a network management device, the SLA quality managing method including: collecting network quality information; determining when SLA network quality is determined; if it is determined that it is not when the SLA network quality is determined, managing SLA network quality; and building the SLA quality information when determining the SLA network quality.

The managing the SLA network quality may include: generating SLA quality monitoring information; when there is a possibility of SLA provisioning quality violation, issuing an alarm of SLA provisioning quality violation to an operation manager; and storing SLA provisioning quality monitoring history information.

The SLA quality managing method may further include, after the building the SLA quality information: confirming the violation or non-violation of the SLA quality using the built SLA quality information; if it is determined that it violates the SLA quality, transmitting SLA quality violation information to a device for discretely managing quality of an SLA that performs a compensation process; and transmitting the SLA quality history information to the device for discretely managing quality of the SLA.

Another exemplary embodiment of the present invention provides an SLA managing system, including: a provisioning management device generating provisioning work and SLA quality information in provisioning; a fault management device that generates work on faults and SLA quality information on faults; a network quality management device that generates work on network quality and SLA quality information on network quality; and a device for managing quality of an SLA that shares SLA quality information on the provisioning work generated by the provisioning management device, SLA quality information on faults generated by the fault management device, and SLA quality information on the network quality generated by the network quality management device to perform statistical compensation processing.

Each of the provisioning management device, the fault management device, and the network quality management device may include an SLA quality monitoring unit that generates SLA quality violation information while performing SLA quality monitoring activity, an SLA quality alarm unit that performs the SLA quality monitoring activity and at the same time issues an alarm to an operation manager when there is a possibility of SLA quality violation; and an SLA quality violation management unit that determines SLA quality violation or not and transmits it to the device for discretely managing quality of an SLA that generates the SLA quality violation information based thereon to perform the compensation processing.

The provisioning management device further includes a processing unit that performs provisioning subscription acceptance and provisioning management, and a storage unit that stores subscriber information regarding the provisioning subscription and provisioning information.

The fault management device may further include a processing unit that performs the fault acceptance and the fault recovery, and a storage unit that stores the fault information and the fault recovery processing information.

The network quality management device may further include a processing unit that performs the management for maintaining service network quality, and a storage unit that stores quality information managed in the processing unit.

### BRIEF DESCRIPTION OF THE DRAWINGS

FIG. 1 is a block diagram of a service level agreement managing system according to an exemplary embodiment of the present invention;

FIG. 2 is a flowchart showing an operation of a provisioning management device according to an exemplary embodiment of the present invention;

FIG. 3 is a flowchart showing an operation of a fault management device according to the exemplary embodiment of the present invention; and

FIG. 4 is a flowchart showing an operation of a network quality management device according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation, and can be implemented by hardware components or software components and combinations thereof.

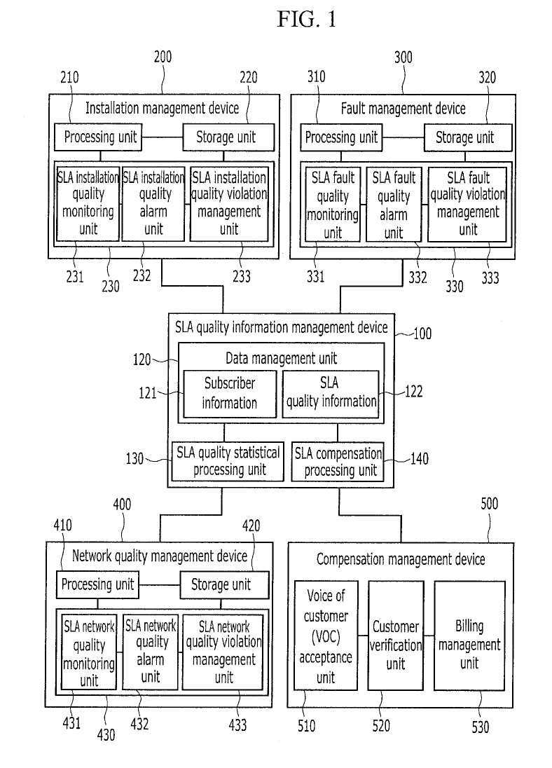

Hereinafter, a service level agreement managing system according to an exemplary embodiment of the present invention will be described in detail with reference to FIG. 1.

FIG. 1 is a block diagram of a service level agreement managing system according to an exemplary embodiment of the present invention.

Referring to FIG. 1, a service level agreement (SLA) managing system according to an exemplary embodiment of the present invention includes an SLA quality information management device 100, a provisioning management device 200, a fault management device 300, a network quality management device 400, and a compensation management device 500.

The SLA quality information management device 100 interacts with an SLA quality information generation device such as a provisioning management device 200, a fault management device 300, a network quality management device 400, etc. through a network to manage SLA quality information. The SLA quality information management device 100 includes a data management unit 120, an SLA quality statistical processing unit 130, and an SLA compensation processing unit 140.

The data management unit 120 receives subscription information 121 from the provisioning management device 200, and shares and stores SLA quality information 122 that is generated by the provisioning management device 200, the fault management device 300, and the network quality management device 400.

The SLA quality statistical processing unit 130 generates statistical information on the SLA quality based on the SLA quality information that is stored in the data management unit 120.

The SLA compensation processing unit 140 interacts with the compensation management device 500 according to the processing result of the SLA quality statistical processing unit 130 to perform the compensation processing on the SLA quality violation.

The provisioning management device 200 performs provisioning work and generates SLA quality information on the provisioning work and transmits it to an SLA quality information management device 100. The provisioning management device 200 includes a processing unit 210, a storage unit 220, and an SLA provisioning quality management unit 230.

The processing unit 210 performs basic provisioning work, that is, provisioning subscription acceptance and management.

The storage unit 220 stores subscriber information and provisioning information.

The SLA provisioning quality management unit 230 generates the SLA provisioning quality information that is the SLA quality information on the provisioning work, and includes an SLA provisioning quality monitoring unit 231, an SLA provisioning quality alarm unit 232, and an SLA provisioning quality violation management unit 233.

The SLA provisioning quality monitoring unit 231 uses provisioning acceptance information that is received through the processing unit 210 and is stored in the storage unit 220 to generate and manage the quality monitoring information.

The SLA provisioning quality alarm unit 232 issues an alarm to an operation manager when there is a possibility of violation during the monitoring of the provisioning quality.

The SLA provisioning quality violation management unit 233 determines the violation or not of the SLA quality for the provisioning quality when the provisioning is completed, and generates and manages the quality violation information based thereon.

The fault management device 300 performs the fault processing work, and generates the SLA quality information associated with the fault and transmits it to the SLA quality information management device 100. The fault management device 300 includes a processing unit 310, a storage unit 320, and an SLA fault quality management unit 330.

The processing unit 310 performs fault acceptance and fault recovery processing.

The storage unit 320 stores the fault information accepted into the processing unit 310 and the fault recovery information in the processing unit 310.

The SLA fault quality management unit 330 generates the SLA fault quality information that is the SLA quality information on the fault processing, and includes an SLA fault quality monitoring unit 331, an SLA fault quality alarm unit 332 and an SLA fault quality violation management unit 333.

The SLA fault quality monitoring unit 331 uses the fault acceptance information received through the processing unit 310 and stored in the storage unit 320 to generate and manage the quality monitoring information.

The SLA fault quality alarm unit 332 issues an alarm to the corresponding operation manager when there is a possibility of violation during the monitoring of the fault quality.

The SLA fault quality violation management unit 333 determines the violation or not of the SLA quality for the fault quality when the fault recovery is completed, and generates and manages the quality violation information based thereon.

The network quality management device 400 performs the network quality management work, and generates the SLA quality information on the network quality and transmits it to the SLA quality information management device 100. The network quality management device 400 includes a processing unit 410, a storage unit 420, and an SLA network quality management device 430.

The processing unit 410 performs a management function to maintain service network quality.

The storage unit 420 stores the network quality information that is managed in the processing unit 410.

The network quality management device 430 generates the SLA network quality information that is the SLA quality information on the network quality, and includes an SLA network quality monitoring unit 431, an SLA network quality alarm unit 432, and an SLA network quality violation management unit 433.

The SLA network quality monitoring unit 431 uses the network quality information collected and processed through the processing unit 410 to generate and manage the quality monitoring information.

The SLA network quality alarm unit 432 issues an alarm to the corresponding operation manager when there is a possibility of violation during the monitoring of the network quality.

The SLA provisioning quality violation management unit 433 determines the violation or not of the SLA quality for the provisioning quality when the network quality management period is completed, and generates and manages the quality violation information based thereon.

The compensation management device 500 performs the compensation processing due to the SLA quality violation according to the instructions of the SLA compensation processing unit 140 of the SLA quality information management device 100. The compensation management device 500 includes a voice of customer (VOC) acceptance unit 510, a customer verification unit 520, and a billing management unit 530.

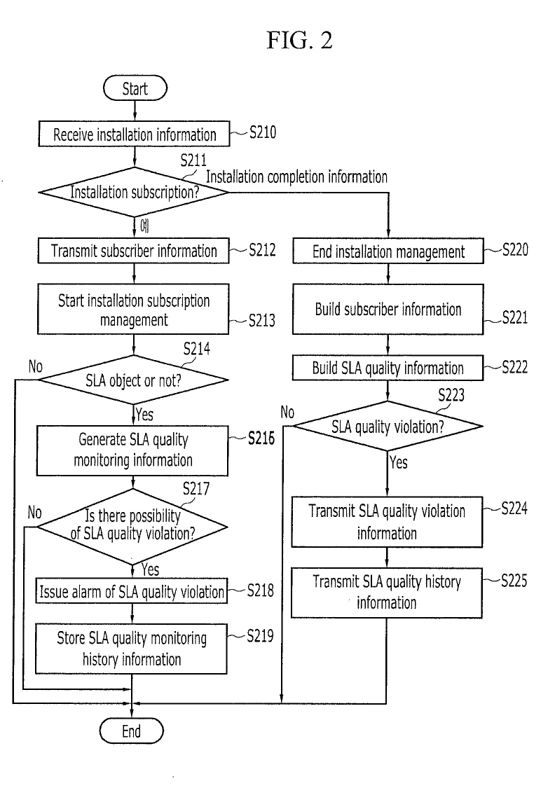

Hereinafter, the operation of the provisioning management device 200 according to an exemplary embodiment of the present invention will be described in detail with reference to FIG. 2.

FIG. 2 is a flowchart showing an operation of a provisioning management device according to an exemplary embodiment of the present invention.

Referring to FIG. 2, the provisioning management device 200 receives the provisioning information through the processing unit 210 (S210), and confirms whether the received provisioning information is provisioning subscription information or provisioning completion information (S211).

As a the confirmation result, when the received provisioning information is the provisioning subscription, the subscriber information is stored in the storage unit 220 and the subscriber information 121 is transmitted to the data management unit 120 of the SLA quality information management device 100 (S212). Then, the provisioning management device 200 starts the provisioning subscription management (S213).

The provisioning management device 200 confirms whether the corresponding subscriber information is an SLA management object (S214). As the confirmation result, when the corresponding subscriber information is the SLA management object, the provisioning management device 200 generates the SLA quality monitoring information (S216). In addition, the provisioning management device 200 determines whether there is a possibility of the SLA provisioning quality violation while performing the SLA provisioning quality monitoring activity (S217). As the determination result, if it is determined that there is a possibility of the SLA provisioning quality violation, it issues an alarm of the SLA provisioning quality violation to the corresponding operation manager (S218).

Then, the provisioning management device 200 stores the SLA provisioning quality monitoring history information (S219) and continuously performs the provisioning quality monitoring activity.

Meanwhile, as the result of confirming the provisioning information (S211), if it is determined that the provisioning information is a provisioning completion information, the provisioning management device 200 ends the provisioning management function (S220). Then, the provisioning management device 200 receives the subscriber information 121 from the SLA quality information management device 100 to update the subscriber information, thereby building the subscriber information (S221) and building and storing the SLA provisioning quality information (S222).

Then, the provisioning management device 200 uses the built SLA provisioning quality information to confirm the violation or not of the SLA quality (S223). As the confirmation result, in the case of the violation of the SLA quality, the SLA quality violation information is transmitted to the SLA quality information management device 100 (S224) and the SLA quality history information is transmitted to the SLA quality information management device 100 (S225).

Meanwhile, the SLA quality information management device 100 stores the SLA quality violation information and the SLA quality history information, which are received from the provisioning management device 200, in the data management unit 120.

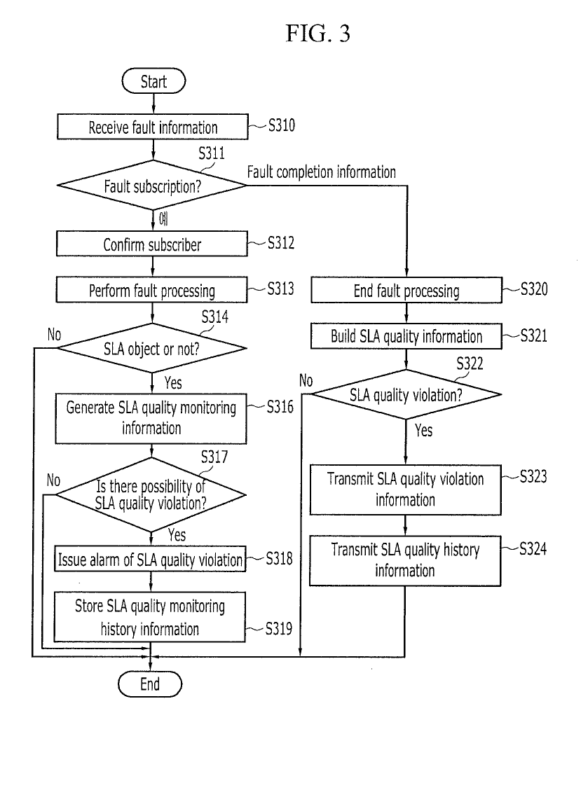

Hereinafter, the operation of the fault management device 300 according to the exemplary embodiment of the present invention will be described in detail with reference to FIG. 3.

FIG. 3 is a flowchart showing an operation of a fault management device according to the exemplary embodiment of the present invention.

Referring to FIG. 3, the fault management device 300 first receives the fault information through the processing unit 310 (S310) and confirms whether the received fault information is the fault acceptance information or the fault recovered information (S311).

As the confirmation result, if it is determined that the received fault information is the fault acceptance, it confirms the service subscriber or not (S312) and performs the fault processing (S313).

Thereafter, the SLA fault quality management unit 330 of the fault management device 300 uses the fault acceptance information to confirm whether the corresponding subscriber is the SLA fault quality management object (S314). As the confirmation result, if it is determined that the corresponding subscriber is the SLA fault quality management object, the fault management device 300 performs the SLA fault quality monitoring activity to generate the SLA quality monitoring information (S316).

In addition, the fault management device 300 determines whether there is a possibility of the SLA fault quality violation while performing the SLA fault quality monitoring activity (S317). As the determination result, if it is determined that there is a possibility of the SLA fault quality violation, it issues an alarm of the SLA fault quality violation to the corresponding operation manager (S318).

Then, the fault management device 300 stores the SLA fault quality monitoring history information (S319) and continuously performs the fault quality monitoring activity.

Meanwhile, as a result of confirming the fault information (S311), when the fault information is the fault recovered information, the fault management device 300 ends the fault processing function (S320). Then, the fault management device 300 receives the SLA fault quality information from the SLA quality information management device 100 to build and store the SLA fault quality information (S321).

Then, the fault management device 300 uses the built SLA fault quality information to confirm the violation or not of the SLA quality (S322). As the confirmation result, in the case of the violation of the SLA quality, the SLA quality violation information is transmitted to the SLA quality information management device 100 (S323), and the SLA quality history information is also transmitted to the SLA quality information management device 100 (S324).

Meanwhile, the SLA quality information management device 100 stores the SLA quality violation information and the SLA quality history information, which are received from the fault management device 300, in the data management unit 120.

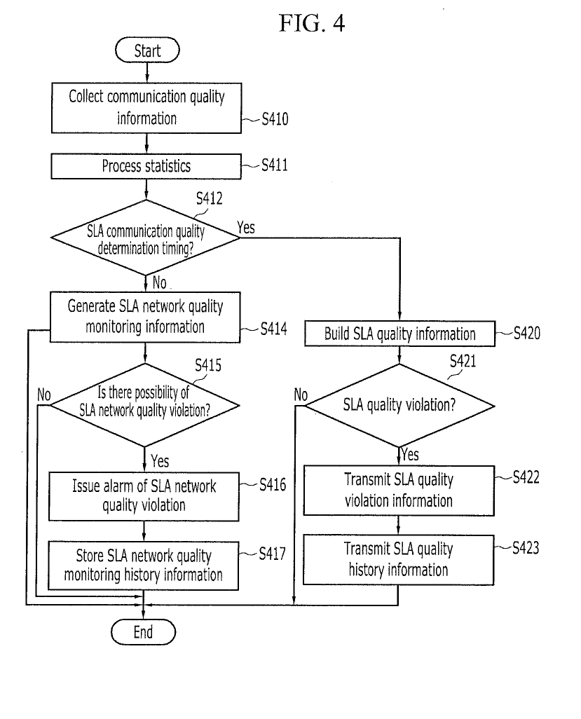

Hereinafter, the network quality management device 400 according to the exemplary embodiment of the present invention will be described in detail with reference to FIG. 4.

FIG. 4 is a flowchart showing an operation of a network quality management device according to an exemplary embodiment of the present invention.

Referring to FIG. 4, the network quality management device 400 periodically collects the network quality information through a processing unit 410 (S410) and statistically processes the collected network quality information (S411).

Then, the network quality management device 400 determines when the billing period-based SLA network quality is determined (S412). As the determination result, when not determining the SLA network quality, the network quality management device 400 performs the SLA network quality monitoring activity to generate the SLA network quality monitoring information (S414).

In addition, the network quality management device 400 determines whether there is a possibility of the SLA network quality while performing the SLA network quality monitoring activity (S415). As the determination result, if it is determined that there is a possibility of the SLA network quality violation, it issues an alarm of the SLA network quality violation to the corresponding operation manager (S416).

Then, the network quality management device 400 stores the SLA network quality monitoring history information (S417) and continuously performs the network quality monitoring activity.

Meanwhile, as a result of determining when the SLA network quality is determined (S412), when determining the SLA network quality, the provisioning information is the provisioning completion information, the network quality management device 400 receives the SLA fault quality information from the SLA quality information management device 100 and builds and stores the SLA fault quality information (S420).

Then, the network quality management device 400 uses the built SLA fault quality information to confirm the violation or not of the SLA quality (S421). As the confirmation result, in the case of the violation of the SLA quality, the SLA quality violation information is transmitted to the SLA quality information management device 100 (S422), and the SLA quality history information is also transmitted to the SLA quality information management device 100 (S423).

Meanwhile, the SLA quality information management device 100 stores the SLA quality violation information and the SLA quality history information, which are received from the network quality management device 400, in the data management unit 120.

As such, in each of the SLA quality information generation devices such as the provisioning management device 200, the fault management device 300, and the network quality management device 400, the SLA quality information is generated and transmitted to the SLA quality information management device 100 in real time to minimize errors in the information for managing quality and secure the real-time, thereby increasing the reliability of data. In addition, the SLA quality information management device 100 can actively reflect the situations of the provisioning management device 200, the fault management device 300, and the network quality management device 400, thereby making it possible to efficiently perform the system operation.

According to the present invention, the reliability of data can be increased by minimizing errors of information for managing quality and securing real-time managing of the service level agreement. In addition, it can efficiently perform the system operation by actively reflecting changes in functions, etc. of the convergence system into the system for managing quality of service level agreement.

The above-mentioned exemplary embodiments of the present invention are not embodied only by an apparatus and method. Alternatively, the above-mentioned exemplary embodiments may be embodied by a program performing functions that correspond to the configuration of the exemplary embodiments of the present invention, or a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An service level agreement (SLA) quality information management device that manages quality of the SLA, comprising:
a data management unit that shares SLA quality information generated by each of a provisioning management device, a fault management device, and a network quality management device with the provisioning management device, the fault management device, and the network quality management device and stores it;
a statistical processing unit that generates SLA quality statistical information based on the SLA quality information; and
a compensation processing unit that processes compensation for violation of the SLA quality based on the SLA quality statistical information.

2. The SLA quality information management device of claim 1, wherein
the data management unit further receives and stores subscriber information from the provisioning management device.

3. An SLA quality managing method by a provisioning management device, comprising:
determining whether provisioning information is provisioning subscription information or provisioning completion information by receiving the provisioning information;
when the provisioning information is the provisioning subscription information, performing monitoring information generation for monitoring the SLA quality and provisioning subscription management; and
when the provisioning information is the provisioning completion information, determining whether it violates the SLA quality and building the SLA quality information.

4. The SLA quality managing method of claim 3, wherein
the performing the provisioning subscription management comprises:
confirming whether a subscriber is an object of the SLA management;
generating SLA quality monitoring information for the subscriber;
when there is the possibility of the SLA provisioning quality violation, issuing an alarm of the SLA provisioning quality violation to an operation manager; and
storing SLA provisioning quality monitoring history information.

5. The SLA quality managing method of claim 3, further comprising,
after the building of the SLA quality information:
confirming violation or non-violation of the SLA quality using the built SLA quality information;
if it is determined that it violates the SLA quality, transmitting SLA quality violation information to a SLA quality information management device that performs a compensation process; and
transmitting the SLA quality history information to the SLA quality information management device.

6. The SLA quality managing method of claim 3, further comprising
transmitting the information on the subscriber to the SLA quality information management device.

7. An SLA quality managing method by a fault management device, comprising:
determining whether fault information is fault acceptance information or fault recovered information by receiving fault information;
when the fault information is the fault acceptance information, generating SLA quality monitoring information and performing fault processing; and
when the fault information is the fault recovered information, determining SLA quality violation and building SLA quality information.

8. The SLA quality managing method of claim 7, wherein
the performing the fault processing comprises:
confirming whether a subscriber is on object of the SLA management;
generating SLA quality monitoring information for the subscriber;
when there is the possibility of the SLA provisioning quality violation, issuing an alarm of the SLA provisioning quality violation to an operation manager; and
storing SLA provisioning quality monitoring history information.

9. The SLA quality managing method of claim 7, further comprising,
after the building of the SLA quality information:
confirming the violation or non-violation of the SLA quality using the built SLA quality information;
if it is determined that it violates the SLA quality, transmitting SLA quality violation information to a SLA quality information management device A that performs a compensation process; and
transmitting the SLA quality history information to the SLA quality information management device.

10. The SLA quality managing method of claim 7, further comprising
confirming the subscriber followed by performing the fault processing.

11. An SLA quality managing method by a network management device, comprising:
collecting network quality information;
determining when SLA network quality is determined;
if it is determined that it is not when the SLA network quality is determined, managing SLA network quality; and
building the SLA quality information when determining the SLA network quality.

12. The SLA quality managing method of claim 11, wherein
the managing the SLA network quality comprises:
generating SLA quality monitoring information;
when there is a possibility of SLA provisioning quality violation, issuing an alarm of SLA provisioning quality violation to an operation manager; and
storing SLA provisioning quality monitoring history information.

13. The SLA quality managing method of claim 11, further comprising,
after the building of the SLA quality information:
confirming the violation or non-violation of the SLA quality using the built SLA quality information;
if it is determined that it violates the SLA quality, transmitting SLA quality violation information to a SLA quality information management device that performs a compensation process; and
transmitting the SLA quality history information to the SLA quality information management device.

14. An SLA managing system, comprising:
a provisioning management device generating provisioning work and SLA quality information in provisioning;
a fault management device that generates work on faults and SLA quality information on faults;
a network quality management device that generates work on network quality and SLA quality information on network quality; and
a SLA quality information management device that shares SLA quality information on the provisioning work generated by the provisioning management device, SLA quality information on faults generated by the fault management device, and SLA quality information on the network quality generated by the network quality management device to perform statistical compensation processing.

15. The SLA managing system of claim 14, wherein
each of the provisioning management device, the fault management device, and the network quality management device includes:
an SLA quality monitoring unit that generates SLA quality violation information while performing SLA quality monitoring activity;
an SLA quality alarm unit that performs the SLA quality monitoring activity, and at the same time, issues an alarm to an operation manager when there is a possibility of SLA quality violation; and
an SLA quality violation management unit that determines SLA quality violation or not and transmits it to the SLA quality information management device that generates the SLA quality violation information based thereon to perform the compensation processing.

16. The SLA managing system of claim 15, wherein
the provisioning management device further comprises:
a processing unit that performs provisioning subscription acceptance and provisioning management; and
a storage unit that stores subscriber information on the provisioning subscription acceptance and provisioning information.

17. The SLA managing system of claim 15, wherein
the fault management device further comprises
a processing unit that performs the fault acceptance and the fault recovery, and
a storage unit that stores the fault information and the fault recovery processing information.

18. The SLA managing system of claim 15, wherein
the network quality management device further comprises
a processing unit that performs the management for maintaining service network quality, and
a storage unit that stores quality information managed in the processing unit.
